(19) United States
(12) Patent Application Publication
(10) Pub. No.: US 2016/0188132 A1
(43) Pub. Date: Jun. 30, 2016

(54) SYSTEM, METHOD, AND GRAPHICAL USER INTERFACE FOR PRESENTING AND/OR PLAYING A GAME

(71) Applicants: Pete O'Heeron, Houston, TX (US); Scott A. Marrone, Nashville, TN (US)

(72) Inventors: Pete O'Heeron, Houston, TX (US); Scott A. Marrone, Nashville, TN (US)

(21) Appl. No.: 14/980,245

(22) Filed: Dec. 28, 2015

Related U.S. Application Data
(60) Provisional application No. 62/096,994, filed on Dec. 26, 2014.

(51) Int. Cl. G06F 3/0482; A63F 13/46; A63F 13/80; A63F 13/85; A63F 13/23; A63F 13/44

(52) U.S. Cl. CPC G06F 3/0482; A63F 13/23; A63F 13/44; A63F 13/80; A63F 13/85; A63F 13/46

(57) ABSTRACT

Methods and systems are provided of presenting a game on user interface of a computing device including the steps of resenting a player with a countdown timer, a letter from the alphabet, and one or more instructions where the player is expected to enter the name of an artist beginning with the letter from the alphabet, receiving a player submission, if the countdown timer has not elapsed, determining whether or not the player submission is valid, and if the player response is valid, awarding points to the player for a matched a name wherein the points are equal to the amount of time remaining.

### CROSS-REFERENCE TO RELATED APPLICATION

This application claims benefit to U.S. Provisional Patent Application Ser. No. 62/096,994, filed on Dec. 26, 2014, which is incorporated by reference herein.

### TECHNICAL FIELD

The present disclosure is generally related to a system, apparatus, method, computer readable medium and graphical user interface for presenting a game and/or interacting with a user of a computing device. More particularly, the present disclosure is related to a user interactive game relating to music and/or to identify musical bands.

### BRIEF SUMMARY

Example embodiments of the present disclosure provide systems of presenting a game. Briefly described, in architecture, one example embodiment of the system, among others, can be implemented as follows: at least one memory operable to store computer-executable instructions, at least one communications interface to access the at least one memory, and at least one processor configured to access the at least one memory via the at least one communications interface and execute the computer-executable instructions to, present a player with a countdown timer, a character comprising a letter or number, and one or more instructions where the player is expected to enter the name of an artist based at least in part on the character, receive a player submission, if the countdown timer has not elapsed, determine whether or not the player submission matches a name of an artist in a data repository, and if the player response is valid, award points to the player for a matched a name wherein the points are equal to the amount of time remaining.

Embodiments of the present disclosure can also be viewed as providing methods for presenting a game on user interface of a computing device. In this regard, one embodiment of such a method, among others, can be broadly summarized by the following steps: presenting a player with a countdown timer, a letter from the alphabet, and one or more instructions where the player is expected to enter the name of an artist beginning with the letter from the alphabet, receiving a player submission, if the countdown timer has not elapsed, determining whether or not the player submission is valid, if the player response is valid, awarding points to the player for a matched a name wherein the points are equal to the amount of time remaining, after receiving a predetermined number of correct player responses, presenting the player with a trivia countdown timer, a trivia question, and multiple choice answers, receiving a player trivia response, if the trivia countdown timer has not elapsed, determine if the player trivia response is valid, if the player trivia response is valid, award the player with points.

According to yet another embodiment of the present disclosure, a method for presenting a game on user interface of a computing device including the steps of presenting a first player with a countdown timer, a character comprising a letter or number, and one or more instructions where the player is expected to enter the name of an artist based at least in part on the character, receiving a first player submission, if the countdown timer has not elapsed, determining whether or not the first player submission is valid, if the first player response is valid, awarding points to the first player for a matched a name wherein the points are equal to the amount of time remaining, presenting a second player with a countdown timer, the first player response, and one or more instructions where the second player is expected to enter the name of an artist based at least in part on the first player response, receiving a second player submission, if the countdown timer has not elapsed, determining whether or not the second player submission is valid, if the second player response is valid, awarding points to the first player for a matched a name wherein the points are equal to the amount of time remaining, and presenting the second player with a countdown timer, the second player response, and one or more instructions where the first player is expected to enter the name of an artist based at least in part on the second player response.

Disclosed herein are a system, method, apparatus, computer readable media, and graphical user interface for presenting information and interacting with a user. Also disclosed are such a system, method, apparatus, and graphical user interface for presenting a game or gaming system and interacting with the user(s) therewith, via a graphical user interface on a computing device or console. In one aspect, the method is a computer-implemented method and the system may include a handheld or locally stationed device connected with one or more processor(s), a memory storing programmable instructions, and input/output user interface. According to a further aspect of the disclosure, the game is embodied, structured, and/or played on a graphical user interface of a mobile device. The game involves eliciting entries from a user(s) as to the identity of a band in accordance with presented criteria.

### BRIEF DESCRIPTION OF THE DRAWINGS

A more complete and thorough understanding of the present embodiments and advantages thereof may be acquired by referring to the following description taken in conjunction with the accompanying drawings:

FIG. 1 illustrates an exemplary environment in which an embodiment in accordance with the present disclosure may be practiced.

FIG. 2 illustrates an example system for supporting provision of an interactive game according to an example embodiment of the disclosure.

FIGS. 3 A-C show exemplary screen shots of the game in accordance with one or more embodiments of the present disclosure.

FIGS. 4 A-C show exemplary screen shots of the game in accordance with one or more embodiments of the present disclosure.

FIGS. 5 A-C show exemplary screen shots of the game in accordance with one or more embodiments of the present disclosure.

FIGS. 6 A-C show exemplary screen shots of the game in accordance with one or more embodiments of the present disclosure.

FIG. 7 schematically illustrates local and third party sources of artist information in accordance with an example embodiment of the disclosure.

FIG. 8 is a block diagram illustration of a method in accordance with an example embodiment of the disclosure.

FIG. 9 is a block diagram illustration of a method in accordance with an example embodiment of the disclosure.

FIG. 10 is a block diagram illustration of a method in accordance with an example embodiment of the disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following description, numerous details are set forth to provide an understanding of the present disclosure. However, it will be understood by those of ordinary skill in the art that the present disclosure may be practiced without these details and that numerous variations or modifications from the described embodiments may be possible. The disclosure will now be described with reference to the figures, in which like reference numerals refer to like, but not necessarily the same or identical, elements throughout. For purposes of clarity in illustrating the characteristics of the present disclosure, proportional relationships of the elements have not necessarily been maintained in the figures.

Specific examples pertaining to the game are provided for illustration only. The arrangement of steps in the game process or the components in the system described in respect to a mobile application for the game may be varied in further embodiments in response to different conditions, game modes, and requirements. In such further embodiments, steps may be carried out in a manner involving different graphical displays, queries, analyses thereof, and responses thereto, as well as to different collections of data. Moreover, the description that follows includes exemplary apparatuses, methods, techniques, and instruction sequences that embody techniques of the disclosed subject matter. It is understood, however, that the described embodiments may be practiced without these specific details or employing only portions thereof.

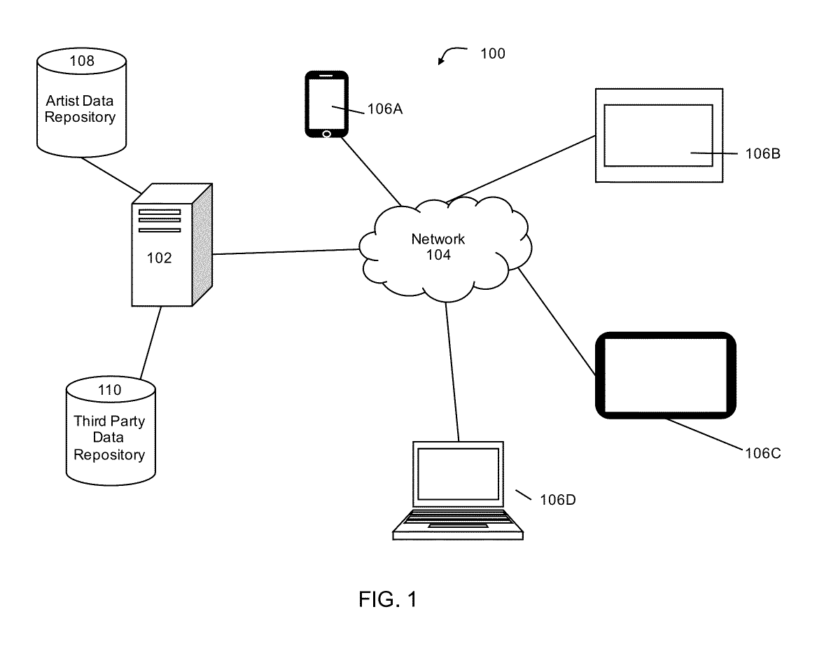

Referring now to the drawings in which like numerals represent like elements or steps throughout the several views, FIG. 1 is block diagram of exemplary environment 100 for providing a system for interactive gameplay in accordance with the present disclosure. Exemplary environment 100 may include a server 102, attached via network 104 to one or more networked devices 106A-D.

As shown server, 102 is attached to one or more data repositories including artist data repository 108 and third party data repository 110. Artist data repository 108 and third party data repository 110 may include information about artists, bands, musicians, songs, albums, graphics, pictures, videos, the contents of audio compact discs, vinyl records, digital song fingerprints, related metadata and one or more links to the like.

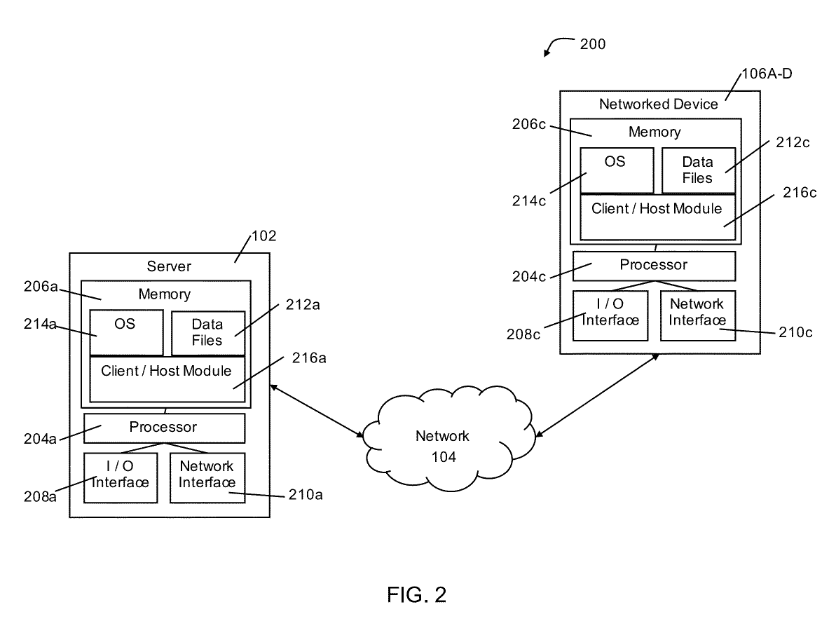

Server 102 may transmit information from one or more data repositories 108, 110 for distribution over network 104 to one or more network connected devices 106A-D. In an example embodiment, server 102 may process and provide information from artist data repository 108 for trivia questions about an artist or band. Server 102 may include a graphics library associated with providing design information associated with layout, fonts, colors, and the like that are associated with a game or game application. Server 102 may comprise a computing device as described below with respect to FIG. 2. Consistent with embodiments of the disclosure, server 102 may comprise one or more software applications (i.e., a series of instructions configured for execution by a processing unit) associated with another component, such as one or more servers or dedicated content devices.

Network 104 (also referred herein as distribution network or communication network) is, generally, used and implemented by a service provider (such as, but not limited to, a wired and/or wireless communication service provider) to enable the service provider to provide, and the service provider's subscribers to receive content and communication services. Network 104 additionally refers to infrastructure, including apparatuses and methods, operative and utilized to communicate data and/or signals between networked devices 106A-D. Similarly, for example and not limitation, network 104 may include current and future wired and/or wireless communication infrastructure for communicating video, audio, or other data and/or signals such as the public switched telephone communication network, cable and/or satellite telecommunications service provider communication networks, other service provider communication networks, and the Internet.

Additionally, network 104 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. Network 104 may also allow for real-time, off-line, and/or batch transactions to be transmitted between or among server 102 and networked devices 106A-D. Due to network connectivity, various methodologies as described herein may be practiced in the context of distributed computing environments.

Although networked devices 106A-D are shown for simplicity in an example embodiment as being in communication with server 102 via one intervening network 104, it is to be understood that other network configurations may be used. For example, intervening network 104 may include a plurality of networks, each with devices such as gateways and routers for providing connectivity between or among networks. Instead of, or in addition to network 104, dedicated communication links may be used to connect the various devices in accordance with example embodiments of the disclosure. For example, one or more networked devices 106A-D may form the basis of network 104 that interconnect one or more networked devices 106A-D.

As shown in FIG. 1, server 102 and networked devices 106A-D may be in communication with each other via a network such as network 104, which as described herein can include one or more separate or shared private and public networks, including the Internet or a publicly switched telephone network.

Networked devices 106A-D may include a stand alone or integrated devices such as a smart phone, tablet, pc, media server, television tuner, satellite or cable receiver, digital video recorder, streaming video player, video game console, Blu-ray player, and the like. Networked devices 106A-D may also include LCD display devices such as a monitor featuring an operating system, media browser, and the ability to run one or more software applications.

Server 102 is shown in communication with multiple data repositories 108, 110. Artist information may be stored in any computer readable form. Artist data repository 108 enables an aspect of the present system and method to retrieve artist and band names for competition.

Additionally, it will be appreciated those of ordinary skill in the art that artist information may include information guide data from one or more sources such as obtaining metadata from Gracenote, CDDB, The Echo Nest, or data from another source such as Tribune Media Services. While illustrated as separate data repositories, it is to be understood that information included in repositories 108 and 110 may be stored in a single repository, or multiple repositories across different locations. Further according to some embodiments of the present disclosure, all or portions of information included in repositories 108 and 110 may be stored or cached locally on one or more networked devices 106A-D.

FIG. 2 illustrates an example system 200 for supporting provision of an interactive game according to an example embodiment of the disclosure. Server 102 and Networked devices 106A-D may be any processor-driven device, such as, but not limited to, a personal computer, laptop computer, smartphone, tablet, handheld computer, dedicated processing device, and/or an array of computing devices. In addition to having processor 204, server 102 and networked devices 106A-D may further include memory 206, input/output (“I/O”) interface(s) 208, and network interface 210. Memory 206 may be any computer-readable medium, coupled to the processor, such as RAM, ROM, and/or a removable storage device for storing data files 212 and a database management system (“DBMS”) to facilitate management of data files 212 and other data stored in memory 206 and/or stored in separate databases. Memory 206 may store data files 212 and various program modules, such as operating system (“OS”) 214 and client module 216. OS 214 may be, but is not limited to, Microsoft Windows®, Apple OS X®, Apple iOS, Unix, Oracle Java®, Linux, Android, or a mainframe operating system. Client module 216 may be an Internet browser or other software, including a dedicated program, for interacting with server 102 and networked devices 106A-D.

Suitable processors, such as processors 204 of server 102 and networked devices 106A-D, respectively, may comprise a microprocessor, an ASIC, and/or a state machine. Example processors may include those provided by Intel Corporation, AMD Corporation, Qualcomm, Nvidia, Broadcom, Samsung, TSMC, Apple, and Motorola Corporation. Such processors comprise, or may be in communication with media, for example computer-readable media, which stores instructions that, when executed by the processor, cause the processor to perform the elements described herein.

Generally, each of the memories and data storage devices, such as memories 204 and databases 108, 110 (as shown in FIG. 1), and/or any other memory and data storage device, can store data and information for subsequent retrieval. In this manner, systems can store various received or collected information in memory or a database associated with server 102 and networked devices 106A-D. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

As used herein, the term “computer-readable medium” may describe any form of memory or a propagated signal transmission medium. Propagated signals representing data and computer program instructions may be transferred between network devices and systems. Embodiments of computer-readable media include, but are not limited to, electronic, flash, optical, magnetic, or other storage or transmission device capable of providing a processor with computer-readable instructions. Also, various other forms of computer-readable media may transmit or carry instructions to a computer, including a router, private or public network, or other transmission device or channel, both wired and wireless. The instructions may comprise code from any computer-programming language, including but not limited to, for example, C, C++, C#, Visual Basic, Ruby, Java, Python, Perl, Swift, and JavaScript.

Generally, network devices and systems, server 102 and networked devices 106A-D have hardware and/or software for transmitting and receiving data and/or computer-executable instructions over a communications link and a memory for storing data and/or computer-executable instructions. These network devices and systems may also include a processor for processing data and executing computer-executable instructions locally and over network 104, as well as other internal and peripheral components that are well known in the art.

Still referring to server 102 and networked devices 106A-D, the I/O interface(s) 208 may facilitate communication between the processor 204 and various I/O devices, such as a keyboard, mouse, printer, microphone, speaker, monitor, bar code readers/scanners, RFID readers, and the like. Network interface 210 may take any of a number of forms, such as a network interface card, a modem, a wireless network card, and the like. It will be appreciated that while server 102 and networked devices 106A-D have been illustrated as a single computer or processor, the server 102 and networked devices 106A-D may be comprised of a group of computers or processors, according to an example embodiment of the disclosure.

As previously mentioned, network 104 may take many forms, including a public and/or a private network, such as a cable television distribution network (e.g., a hybrid fiber-coax network), a cellular data network, a metropolitan WiMAX network, and/or the Internet.

Exemplary environment 100 shown in and described with respect to FIGS. 1 and 2 are provided by way of example only. Numerous other operating environments, system architectures, and device configurations are possible. Other system embodiments can include fewer or greater numbers of components and may incorporate some or all of the functionality described with respect to the system components shown in FIGS. 1 and 2.

For example, in one embodiment server 102 and networked devices 106A-D may be implemented as a specialized processing machine that includes hardware and/or software for performing the methods described herein. In addition, the processor and/or processing capabilities of server 102 and networked devices 106A-D, or any portion or combination thereof. Accordingly, embodiments of the disclosure should not be construed as being limited to any particular operating environment, system architecture, or device configuration.

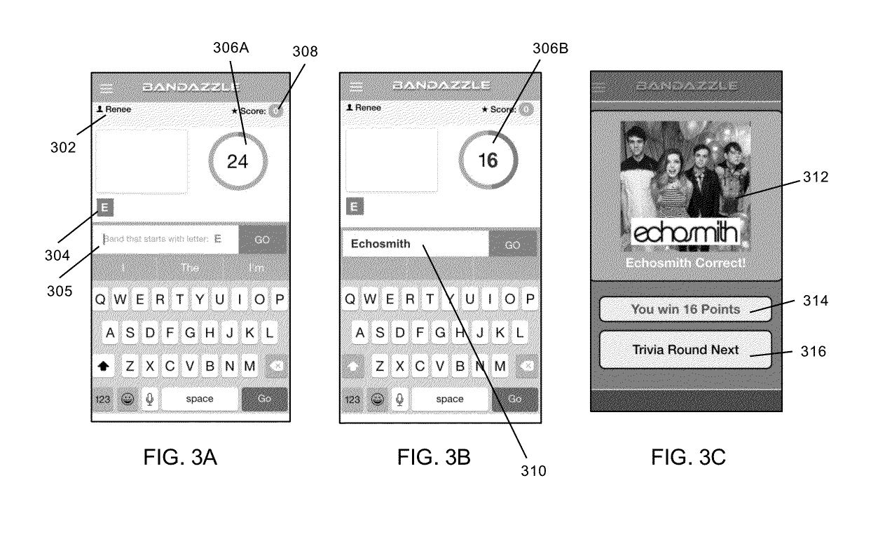

Prior to turning to FIGS. 3 A-C, it should be noted that the terms “artist” and “band” are used interchangeably herein. Additionally, the terms “user” and “player” are used interchangeably, as are the terms “turn” and “round.”

FIGS. 3A-C show exemplary screen shots of the game in accordance with one or more embodiments of the present disclosure. FIG. 3A depicts a screen shown during a letter round portion of the game. On screen 3A is player name 302, presented letter 304, instruction 305, countdown timer 306A, and score 308. According to an aspect of the game, at the start of each letter round, the player is presented with a letter of the alphabet 304 (“E”) and a time limit with a visual countdown clock 306A (“24”). As shown in FIG. 3B, the player has entered and submitted response 310 (“Echosmith”) in response to presented letter 304 and instruction 305. In FIG. 3C, the player is presented with an image of the band 312 and awarded 16 points which is equal to the value of the amount of time remaining 306B (“18”) when the user submitted the response 310. Further shown is a message indicating that next up is the start of the trivia round 316. It will be appreciated that in accordance with certain aspects of the disclosure, letters, numbers, or other characters may be presented to a player.

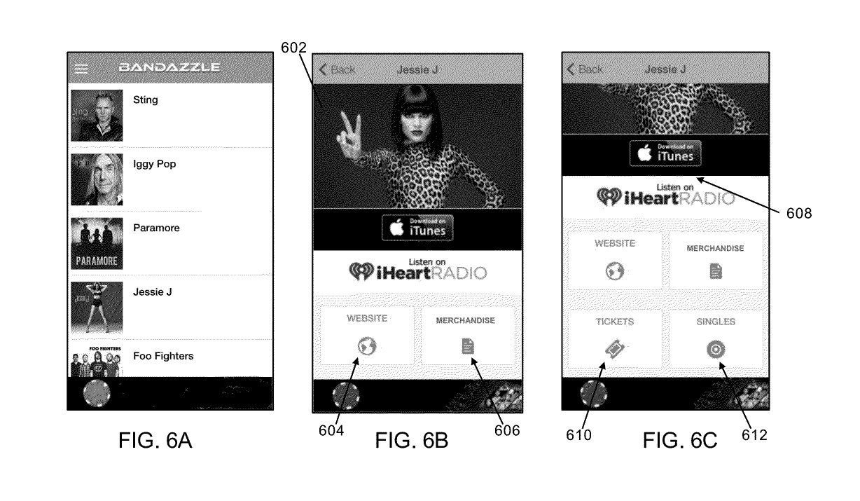

In accordance with another embodiment of the present disclosure, that additional messages may be provided to the player upon a successfully matched response. For example, FIG. 3C may inform the player that Echosmith is currently on tour and that tickets are currently on sale in a local venue and provide a link to purchase tickets such as ticket link 610 as discussed with reference to FIG. 6C. According to another aspect, a message including a link to purchase artist singles such as artist single link 612, or merchandise 606 may be provided to user as discussed with respect to FIG. 6C and FIG. 6B, respectively.

According to an embodiment of the present disclosure, the player is prompted with an instruction to match the first letter, last letter, or another selection such as the third from last letter of the band name. For example, according to one aspect of the game, a player is presented with the band “the Beatles” (which ends in “S”) and a countdown clock with 25 seconds. The player is prompted with an instruction to enter the name of an artist or band that begins with the letter S. So if the player enters “Sugar” (Which begins with “S”) within the allotted time, then the player is successful and whatever time remains will be added to the player score for that round. It will be appreciated by one of ordinary skill in the art that the 25 second time limit is exemplary and that any time limit duration may be used.

In some instances, the name of some artists feature special characters such as e-acute in Beyoncé, or a single or double umlaut as in Motörhead and Hüsker Dü, respectively. In accordance with the present disclosure, it will be appreciated that one or more approaches may be used in determining whether or not a player submitted response is valid/correct. For example, plain text versions for a band name featuring special characters may be accepted as a valid answer. According to another aspect of the disclosure, matching may be performed on the part of one or more data repositories which may employ error correction locally. For example, if the player enters a majority of an artist name correctly, some embodiments of the game will find a match. According to other embodiments, a valid player answer may player be awarded for a name spelled 90% correctly. It is further contemplated that some embodiments may accept a match for “21 pilots” in addition to the technically correct name which is “twenty one pilots.” Additionally, some devices include an autocorrect feature that may improve the spelling of a player response.

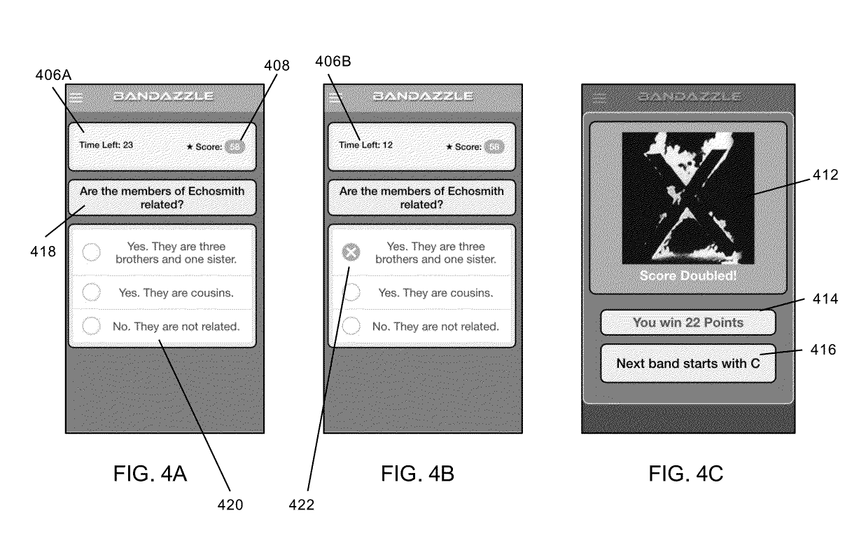

FIGS. 4 A-C show exemplary screen shots of the game in accordance with one or more embodiments of the present disclosure. For example, following a specified number of successfully answered letter rounds, the player is presented with a trivia question with multiple choice answers. In FIG. 4A, the time remaining 406A is shown (“23”) seconds as is the player score 408 (“58”). Additionally, the player is presented with trivia question 418 and multiple choice answers 420. In FIG. 4B, the player has selected and submitted response 422 in response to trivia question 418 with time remaining 406B (“12”). As shown in FIG. 4C, the player is presented with an image of the band 412 and awarded 22 points. Further shown is a message indicating that next up is the start of letter round 416 where the next band name starts with the letter C. It will be appreciated by one of ordinary skill in the art that the while time remaining 406A was shown as 23 seconds, the described time limit is exemplary and that any time limit duration may be used.

According to one aspect of the disclosure, if the player answers the trivia question correctly, the player is awarded bonus points based at least in part on the score from the previous letter round. It will be appreciated that alternate embodiments may present the player with a trivia question after a specified number of successful turns/rounds (such as three) or after an unspecified/random number of successful letter rounds. It should be noted that the number of multiple choice answers may vary as well or take the form of a true/false response.

For example, if the most recent letter round score was 18, if the player correctly answers the trivia question, then the player receives 18 bonus points. In the event that the player does not correctly answer the trivia round question, the player is not penalized, nor does the game end. Instead, the next letter round begins for the player. It will be appreciated that bonus points may be awarded in various ways and is in no way limited to the value of the most recent letter round score.

In accordance with another embodiment of the present disclosure, that additional messages may be provided to the player at the start of the trivia round. For example, a banner ad or message may be displayed to inform the player that Echosmith (or current trivia artist) is currently on tour and that tickets are currently on sale in a local venue based on the location of the player based at least in part on player account profile information or device location services.

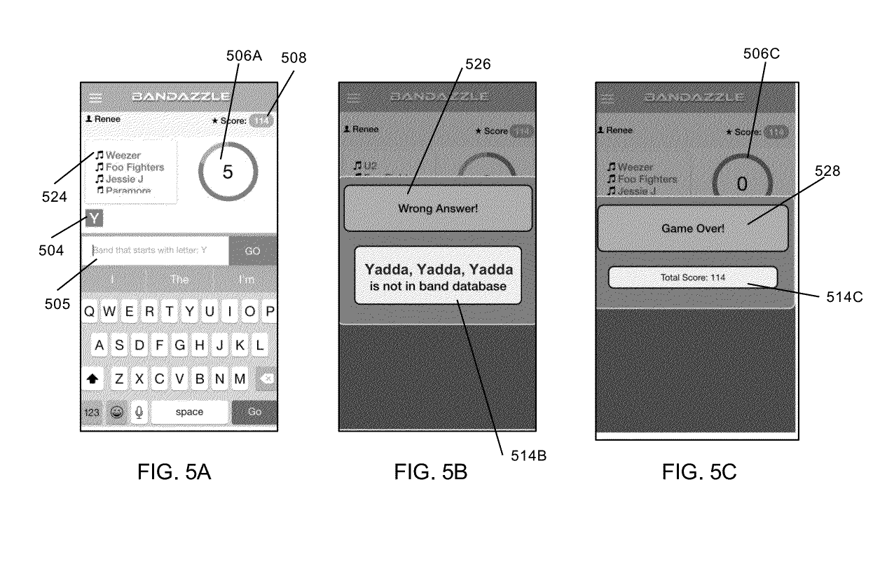

FIGS. 5 A-C show exemplary screen shots of the game in accordance with one or more embodiments of the present disclosure. In FIG. 5A, shown is presented letter 504 (“Y”), instruction 505, player score 508, countdown timer 506A, and a list of correct band answers. According to one aspect of the disclosure, the game ends if the player fails to correctly enter a band or artist name within the allotted time limit. In FIG. 5B, message 514B indicates that the player has submitted the name of a band or artist that is not in the band information repository, and that the answer is wrong per message 526. In FIG. 5C, countdown timer 506C indicates that the time has run out and that the game is over per message 528. Additionally, shown is player's final score of 514C.

FIGS. 6 A-C show exemplary screen shots of the game in accordance with one or more embodiments of the present disclosure. FIG. 6A shows an exemplary screen shot of a screen presented to the player at the end of a game whereby the player is presented with a list of all correct artist letter round answers. In some embodiments according to the present disclosure, the list of artists may include corresponding artist images and/or album artwork. FIG. 6B shows an artist page selected by the player from the list shown in FIG. 6A. According to one embodiment, the artist page includes an artist picture 602 and a link to the artist website 604. Additionally, the artist page includes a link to one or merchandise vendors 606 such as, but not limited to, MerchLove, Sony Signatures, MerchNOW, Hot Topic, and Rockabilia.

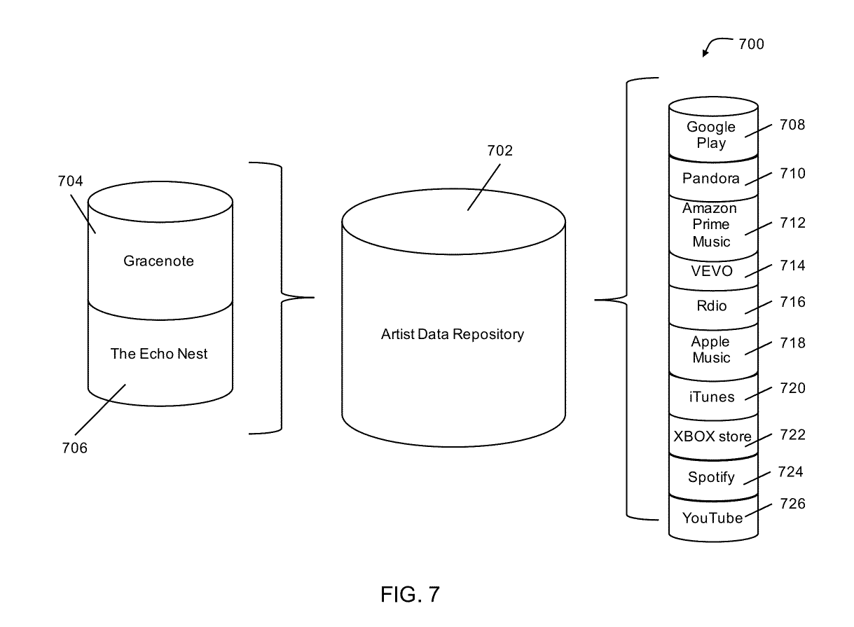

FIG. 6C shows a view of the artist page of FIG. 6B where the player has scrolled down the page. Further options on the artist page include the option to download one or more artist albums on an online music store such as iTunes 608, a link to find concert tickets 610 and a link to purchase one or more artist singles 612. It will be appreciated by one of ordinary skill in the art that additional links may be provided for videos through VEVO, Vimeo and the like. For concert tickets 610, the ticket link may provide links to shows featuring the selected artist on primary or secondary ticket markets including but not limited to Ticketmaster, Live Nation, etix, Eventbright, Vividtickets, SeatGeek, and Stubhub. According to some embodiments of the present disclosure, player geographic location information is provided along with the selected artist to the selected ticket vendor. For artist singles 612, links may be provided to one or more online music stores such as, but not limited to, Amazon Music, iTunes, and the like. It is contemplated by the present disclosure that links, in addition to those described herein, may be provided to download or stream the specified artist's music from one or more third party services further discussed with respect to FIG. 7.

FIG. 7 schematically illustrates exemplary sources of artist and media information 700 in accordance with an example embodiment of the disclosure. Item 702 represents information in an artist data repository such as artist data repository 108 or third party data repository 110 as shown in FIG. 1. It is contemplated by example embodiments of the present disclosure that artist data repository 702 may include information from content sources such as GraceNote 704 and The Echo Nest 706 listing information.

According to further embodiments of the present disclosure, artist data repository 702 may include both paid and free sources. By way of example and not limitation, third party sources include Google Play 708, Pandora 710, Amazon Prime Music 712, VEVO 714, Rdio 716, Apple Music 718, iTunes Store 720, XBOX store 722, Spotify 724, and YouTube 726. It will be appreciated that other third party sources may be configured according to player preferences as well, such as accessing a public or university library media service. Additionally, one or more sources may be accessed via API or SDK.

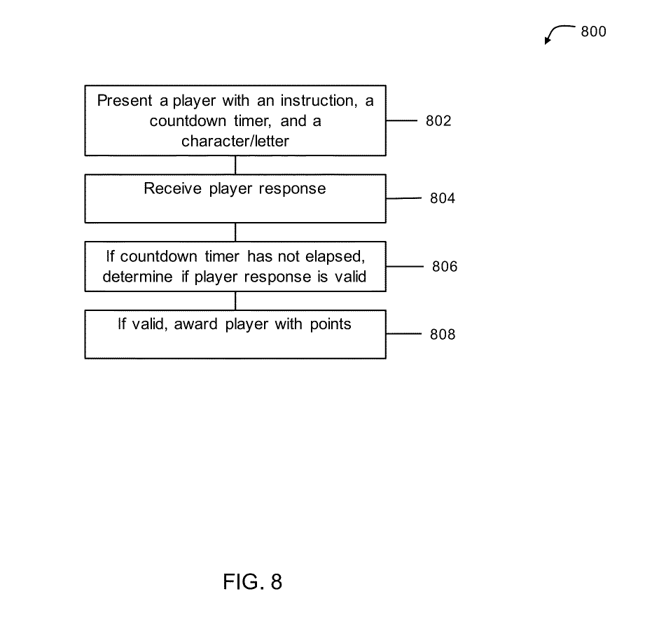

FIG. 8 is a flow diagram illustration 800 for providing presentation of an interactive game according to an example embodiment of the disclosure. In block 802, present a player with an instruction, a countdown timer, and a character/letter. In block 804, Receive player response. In block 806, If countdown timer has not elapsed, determine if player response is valid. In block 808, if valid, award player with points.

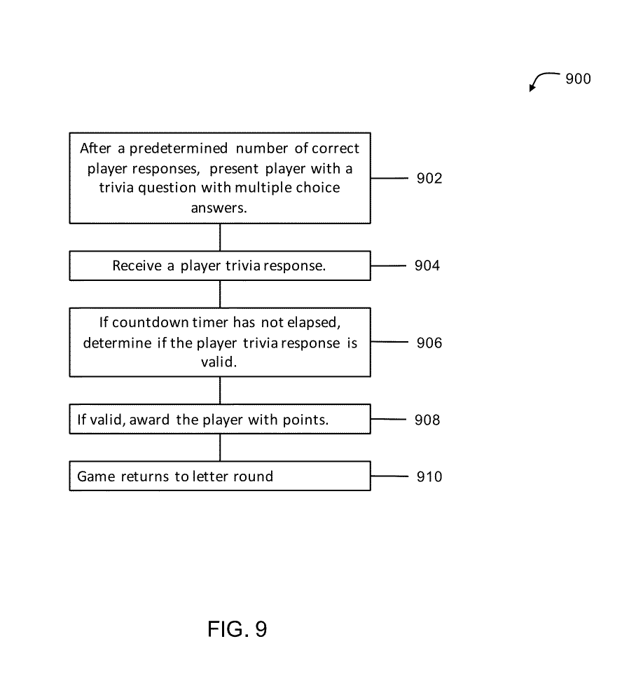

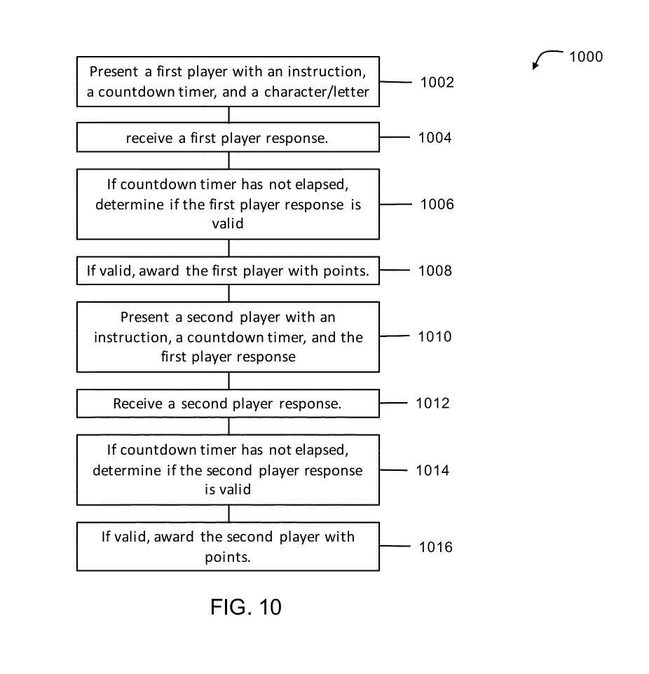

FIG. 9 is a flow diagram illustration 900 for providing presentation of an interactive game according to an alternate example embodiment of the disclosure. In block 902, After a predetermined number of correct player responses, present player with a trivia question with multiple choice answers. In block 904, Receive a player trivia response. In block 906, If countdown timer has not elapsed, determine if the player trivia response is valid. In block 908, If valid, award the player with points. In block 910, the game returns the player to letter round as described in FIGS. 8 and 10.

FIG. 10 is a flow diagram illustration 1000 for providing presentation of an interactive game according to an alternate example embodiment of the disclosure. In block 1002, Present a first player with an instruction, a countdown timer, and a character/letter. In block 1004, receive a first player response. In block 1006, if countdown timer has not elapsed, determine if the first player response is valid. In block 1008, if valid, award the first player with points. In block 1010, Present a second player with an instruction, a countdown timer, and the first player response. In block 1012, Receive a second player response. In block 1014, If countdown timer has not elapsed, determine if the second player response is valid. In block 1014, If valid, award the second player with points. It will be appreciated that the round may repeat returning to the first and second users until the time elapses or an incorrect answer is submitted.

According to an embodiment of the game according to the disclosure, a social challenge mode is provided whereby players can play random users or challenge friends such as Facebook, Game Center friends, or a registered player with an account. According to some embodiments of the present disclosure, in match play, a player must complete their turn within a specified number of days, such as 2 days, to avoid forfeiting the game.

For example, in last letter challenge mode player 1 gives a correct answer and when it is player 2's turn, a correct answer for player 2 starts with the last letter of the player 1's correct answer. By way of example, player 1 is presented with the letter B and enters “Beatles.” Since Beatles ends with the letter S, a correct answer for player 2 is the name of an artist or band that starts with the letter S, such as Santana. For player 1's next turn, since Santana ends with the letter A, player 1 should enter an artist or band name that begins with the A, such as Aerosmith.

It will be appreciated that many variations in the rules/instructions of a particular game are possible including specifying that each player turn involves providing the name of a band that ends with the first letter of the band supplied by the opposing player in the previous turn. It will also be appreciated that the instructions may change between player turns during a contest, such as starting out with matching first letters for the first turn, matching last letters for the next turn, matching second to last letters and the like for subsequent turns. It should be noted that further variations include reducing the amount of time each player gets per turn to provide the name of an artist or band that meets the criteria.

According to some embodiments of the present disclosure, the game further includes a casual play mode in which the user may play against the computer where the computer generates a random letter and the player plays against the countdown clock. For example, some options may include allowing the player to obtain more time via earned or purchased credits such as user coins. For example, the player may use purchased or earned coins to add extra time onto the game clock. Other uses for credits include removing one or more wrong trivia answers with coin credits.

According to some embodiments of the present disclosure, a player may interact with one or more social media platforms through the game. For example, a player may post to Facebook after winning a game, after answering a trivia question correctly, when an achievement is reached, when a badge is won, or to share a trivia question. Posts to social media through the game include links which allow a third party user to click to be directed to the interactive game, or in some instances, to launch the game application on a device.

According to some embodiments of the present disclosure, the band game may be played on a hand-held device such as a smart phone, tablet, and the like, or a digital computing device such as notebook, laptop, desktop, gaming console, dvr, game console, or web browser. According to one embodiment, the game is included as an application on a computing device such as a smart phone or tablet application.

Alternatively, according to an alternate embodiment, an objective of the game is to correctly guess or enter a band name given visual clue(s) presented on a user interface. Visual (or audible) clues may be provided, and may be presented progressively and cumulatively, until a qualified user entry is received by the device or a threshold exceeded (e.g., number of guesses, time, etc.). The user may be scored or receive (or deducted) points depending on the answer, the time and number of clues required before each correct or incorrect answer, and\or the difficulty or skill level associated with the query.

According to another aspect of the disclosure, a player is presented with several game modes including the ability to play against the computer, against a friend, or against a community of players. According to some embodiments of the present disclosure, during game play, the mobile device may detect the geographic vicinity of the player and begin to stream content from the local radio station to the networked device 106A-D. For example, in accordance with one or more embodiments of the present disclosure, if the user has chosen country music as their genre preference and they live in San Antonio, then local iHeart Radio station KAJA may begin to play in the background. According to another embodiment of the present disclosure, advertising for the local station such as banners, will be displayed on a portion of the screen.

Login and Player Accounts. According to an embodiment of the present disclosure, the player may login to the game using email and password or via third party account/social login. Examples of third party accounts logins include Facebook, Google+, Twitter, LastFM, Apple Game Center, Microsoft Xbox Live, Steam, Sony PlayStation Network, Nintendo Network ID, Hyves, LinkedIn, LiveJournal, Myspace, Renren, Yahoo!, WordPress, Paypal, AOL, Foursquare, and OpenID. It will be appreciated by one of ordinary skill in the art that third party logins may make be implemented using one or more authentication APIs and secure system standards including OAuth.

According to another embodiment of the present disclosure player accounts include name, username, profile picture, email address, geographic location, music genre preference, online music account credentials (such as Spotify, Pandora, Apple Music). It will be appreciated that certain embodiments of the game may provide commercial free music streaming music if credentials are provided, but will provide music streaming with commercials if no online music account credentials are provided.

Other embodiments the game may include:
1. Players are ranked daily and the high scorers may win “meet and greets”, backstage passes, preferred seats at shows, or similar incentives;
2. Random trivia from the bands maybe presented to the player for additional points and deeper gaming experience;
3. At the end of the game, each band chosen is shown in a list and the gamer can click on the scroll to see what's going on with the band;
4. Each band in the list includes one or more links to band website, touring schedule, merchandise, videos, music downloads, and Wikipedia.

Rewards. According to some embodiments of the present disclosure, a player may earn coins for daily play. By way of example, the player may earn 3 free coins each day played based on a 24-hour server clock, however, if the player does not come back within a 24-hour period, based on the server clock, the player is not awarded 3 coins.

Certain embodiments of the game reward players for achievements. By way of example and not limitation, according to some embodiments, players may receive credit/coins for reaching achievements based on server date and time for: first day play, 7 days in a row, 14 days in a row, 30 days in a row, 30 non consecutive days, 60 non consecutive days, 100 non consecutive days, 150 non consecutive days, and 250 non consecutive days. Additionally, players may be rewarded with credit/coins for winning a first game, 10 games in a row, 25 games in a row, 25 games, 50 games, 100 games, 10 Challenges, 25 Challenges, 50 Challenges, 100 Challenges, and 250 Challenges. It will be appreciated that credit/coin amounts may vary depending on the relative importance of an achievement. Some embodiments of the game show the player's progress towards an achievement. For example, if the player plays 4 days in a row, the game shows that the player has 3 days left to accomplish a 7 days in a row achievement. Additionally, when a player gains a coin or coins, or completes an achievement, an acknowledgement screen alerts the player that they have gained coins or earned an achievement.

In addition to achievements, some embodiments of the game reward players with badges based at least in part, upon player scores both cumulatively and per game. Examples of player badges include Fan, Front Row, Groupie, Opening Act, Pre-Show, Meet & Greet, VIP, All Access, Star, Super Star, Living Legend, Hall of Fame, and Kind of a Big Deal. In accordance with another embodiment of the present disclosure, badges or coins may be awarded to players for submitting trivia questions and answers for use in the game.

Management of a system-identified collection or network of active game applications, users, and user-related information may be interfaced with one or more third party services such as iHeart radio, Spotify, Pandora, Apple Music, Google Play, Rdio, and the like. Such services may provide music recommendations and aggregate audio content from local stations.

Portions of player usage information may be provided to the third party service to such a platform to increase usage, advertising value, etc. Thus, it is further contemplated that the gaming application can serve as a source for commercial revenue streams such as the following:
1. Ad sales
   a. Banner
   b. Pop up
   c. Start up
   d. Result page/National & Regional
2. Single/Album sales
3. Ticket sales
4. Merchandise sales
5. Premium paid APP
6. Highlight fees. Marketing tools for labels, artists, and promoters.
7. Sell trending data and game metrics.
8. Increase company usage to increase ad value to company sales team.

Notwithstanding the above, the present disclosure relies on a generally computer-implemented and/or software-implemented process of playing a music or band-related game. Accordingly, the flowcharts of FIGS. 8-10 generally illustrate systems and methods according to one or more embodiments in accordance with the present disclosure.

The computing device includes and communicates with a resident processor(s) and memory storing programmable instructions executable to initiate or perform various steps in the process. These programmable instructions are packaged in a software application that can be initiated from or in the computing device. In any event, the computing device includes a graphical user interface to the software application responsive to input by the user and capable of projecting output displays and other activity generated by the application.

The flow chart of FIGS. 8-10 show the architecture, functionality, and operation of a possible implementation of providing an interactive game. In this regard, each block represents a module, segment, or portion of code, which comprises one or more executable instructions for implementing the specified logical function(s). It should also be noted that in some alternative implementations, the functions noted in the blocks may occur out of the order noted in FIGS. 8-10. For example, two blocks shown in succession in FIGS. 8-10 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

The foregoing description has been presented for purposes of illustration and description. It is to be noted that the description is not intended to limit the invention to the various systems, apparatus, processes, media, and graphical user interfaces disclosed herein.

What is claimed is:

1. A method of presenting a game on user interface of a computing device comprising the steps of:
presenting a player with a countdown timer, a letter from the alphabet, and one or more instructions where the player is expected to enter the name of an artist beginning with the letter from the alphabet;
receiving a player submission;
if the countdown timer has not elapsed, determining whether or not the player submission is valid;
if the player response is valid, awarding points to the player for a matched a name wherein the points are equal to the amount of time remaining;
after receiving a predetermined number of correct player responses, presenting the player with a trivia countdown timer, a trivia question, and multiple choice answers;
receiving a player trivia response;
if the trivia countdown timer has not elapsed, determine if the player trivia response is valid;
if the player trivia response is valid, award the player with points.

2. The method of claim 1 wherein the step of determining whether or not the player submission is valid further comprises determining whether or not the player submission matches a name of an artist in a data repository.

3. The method of claim 1 further comprising the step of presenting the player with a game over message to indicate the end of the game if the countdown timer elapses prior to receiving a player submission or if it is determined that the player submission does not match the name of an artist in the data repository.

4. The method of claim 3 further comprising the step of presenting the player with a list of artists comprised of each correct player response wherein each artist in the list includes one or more links to an artist information page.

5. The method of claim 5 wherein the artist information page includes one or more of the following: links to the artist website, links to purchase concert tickets, and links to purchase music by the artist.

6. The method of claim 1 further including the step of, if the player response is valid, presenting the player with a message about the player response with one or more of, links to purchase concert tickets, links to purchase music, or links to stream music.

7. A system for method of presenting a game comprising:
at least one memory operable to store computer-executable instructions;
at least one communications interface to access the at least one memory; and
at least one processor configured to access the at least one memory via the at least one communications interface and execute the computer-executable instructions to:
present a player with a countdown timer, a character comprising a letter or number, and one or more instructions where the player is expected to enter the name of an artist based at least in part on the character;
receive a player submission;
if the countdown timer has not elapsed, determine whether or not the player submission matches a name of an artist in a data repository; and
if the player response is valid, award points to the player for a matched a name wherein the points are equal to the amount of time remaining.

8. The system of claim 7 further comprising computer-executable instructions to:
after a predetermined number of correct player responses, present the player with a trivia question and multiple choice answers;
receive a player trivia response;
if countdown timer has not elapsed, determine if the player trivia response is valid;
if the player trivia response is valid, award the player with points.

9. The system of claim 7 further comprising computer-executable instructions to present the player with a game over message to indicate the end of the game if the countdown timer elapses prior to receiving a player submission or if it is determined that the player submission does not match the name of an artist in the data repository.

10. The system of claim 9 further comprising computer-executable instructions to present the player with a list of artists comprised of each correct player response wherein each artist in the list includes one or more links to an artist information page.

11. The system of claim 9 wherein the artist information page includes one or more of the following: links to the artist website, links to purchase concert tickets, and links to purchase music by the artist.

12. The system of claim 7 further comprising computer-executable instructions, if the player response is valid, present the player with a message about the player response with one or more links to purchase concert tickets, purchase music, or to stream music.

13. A method of presenting a game on user interface of a computing device comprising the steps of:
presenting a first player with a countdown timer, a character comprising a letter or number, and one or more instructions where the player is expected to enter the name of an artist based at least in part on the character;
receiving a first player submission;
if the countdown timer has not elapsed, determining whether or not the first player submission is valid;
if the first player response is valid, awarding points to the first player for a matched a name wherein the points are equal to the amount of time remaining;
presenting a second player with a countdown timer, the first player response, and one or more instructions where the second player is expected to enter the name of an artist based at least in part on the first player response;
receiving a second player submission;
if the countdown timer has not elapsed, determining whether or not the second player submission is valid;
if the second player response is valid, awarding points to the first player for a matched a name wherein the points are equal to the amount of time remaining; and
presenting the second player with a countdown timer, the second player response, and one or more instructions where the first player is expected to enter the name of an artist based at least in part on the second player response.

14. The method of claim 13 wherein the steps of determining whether or not the first and second player submissions are valid further comprises determining whether or not the first and second player submissions match a name of an artist in a data repository.

15. The method of claim 13 further comprising the step of presenting the first or second player with a game over message to indicate the end of the game if the countdown timer elapses prior to receiving the first or second player submission or if it is determined that the first or second player submission does not match the name of an artist in the data repository.

16. The method of claim 15 further comprising the step of presenting the first and second players with a list of artists comprised of each correct first and second player responses wherein each artist in the list includes one or more links to an artist information page.

17. The method of claim 16 wherein the artist information page includes one or more of the following: links to the artist website, links to purchase concert tickets, and links to purchase music by the artist.

18. The method of claim 13 further including the step of, if the first or second player response is valid, presenting the first or second player with a message about the first or second player response with one or more of, links to purchase concert tickets, links to purchase music, or links to stream music.

19. The method of claim 13, wherein one or more of the steps are performed on a server.

20. The method of claim 13 wherein one or more of the steps are performed on a networked device.
